(19) United States
(12) Patent Application Publication
(10) Pub. No.: US 2013/0220900 A1
(43) Pub. Date: Aug. 29, 2013

(54) FILTER COMMUNICATION AND IDENTIFICATION NETWORK

(71) Applicant: CUMMINS FILTRATION IP, INC., (US)

(72) Inventors: Thomas J. MILVERT, Columbus, IN (US); Michael F. MATTERN, Columbus, IN (US); Michael T. ZUROSKI, Sun Prairie, WI (US); James L. WALLS, Cookeville, TN (US); Paul Douglas FREE, Hope, IN (US); David P. GENTER, Columbus, IN (US)

(73) Assignee: CUMMINS FILTRATION IP, INC., Minneapolis, MN (US)

(21) Appl. No.: 13/778,623

(22) Filed: Feb. 27, 2013

Related U.S. Application Data
(60) Provisional application No. 61/603,527, filed on Feb. 27, 2012.

(51) Int. Cl. B01D 35/00

(52) U.S. Cl. CPC B01D 35/005
USPC 210/85

(57) ABSTRACT

A filter, and a system, such as an engine, that uses the filter are described. A wireless tag, such as an IEEE 1902.1 wireless tag, that communicates using long wave magnetic waves is mounted on the filter head or on the filter. The wireless tag is used to communicate data such as filter identifier and status to a data acquisition system. Further, the data acquisition system can interface to an engine control module or other controller to allow specific control action or diagnostics/fault reporting.

### FIELD

This disclosure generally pertains to the field of filtration and managing correct filter useage.

### BACKGROUND

To prevent damage to downstream components and malfunctions of equipment in which a fluid filtration system is used, it is desirable for an appropriately designed filter cartridge to be installed. In addition, it also desirable to prevent fluid flow to downstream component(s) if a filter (or the filter media cartridge thereof) is not installed.

### SUMMARY

This disclosure describes the ability to electrically “key” a filter to the engine (or other system in which the filter is to be used) using a secure protocol. This will allow filter authentication and compatibility checks to be performed on the engine, allowing the engine control system to take appropriate action upon detecting an incompatible or missing filter (or filter media cartridge). For example, the engine control module (ECM) can react to the presence or absence of a filter (or the filter media cartridge of the filter), for example by preventing engine operation (and subsequent engine damage) if an appropriate filter (or the filter media cartridge thereof) is not present or if no filter (or the filter media cartridge thereof) is present. It will also allow verification of the periodic maintenance of the filter. Finally, it will allow for enhanced filter status reporting using variety of mediums (e.g. handheld devices, “home office” systems via telematics, traditional service tools, etc.).

Communicating key filter information back to a central computing device such as an engine control module (ECM) can provide the opportunity to create advanced diagnostics reporting and engine protection. Numerous algorithms can be implemented to use this data. As an example, if a filter (or filter media cartridge) is missing, logic in the ECM could prevent an engine from starting and/or report a diagnostic trouble code to an operator and/or technician. In the case of a plugged or greatly restricted filter or filter media cartridge, logic in the ECM could command an engine derate or place the engine into an alternate operational mode and/or report a diagnostic trouble code to an operator and/or technician. In addition, since the ECM knows duty cycle and other operational states of the engine, it is possible to trend to filter information to provide more dynamic maintenance intervals (longer intervals for gentle use & shorter for harsh use).

Integrating electronics into a filter presents several challenges. One of them is harnessing the supply power and other electrical interfaces. Another is ensuring that the information is secure and tamper resistant. A third problem arises when filters are designed with removable filter media cartridges, such that the filter media cartridge can be left out of the filter housing.

In one embodiment, a filter includes a filter housing, a filter media cartridge removably disposed within the filter housing, and a wireless communication tag mounted on the filter housing or on the filter media cartridge. The tag can be, for example, an IEEE 1902.1 wireless tag, or any type of wireless tag that permits communications with a predetermined remote device, for example the engine control module (ECM) or perhaps even directly to a handheld device such as a mobile smartphone. This will provide certain information that can be acted on. For example, but not limited to, the presence or absence of the filter (or the filter media cartridge thereof) can be detected, the type of filter (or filter media cartridge) can be detected to determine whether that filter (or the filter media cartridge) is appropriate for the engine, a measure of when the filter (or the filter media cartridge) was installed or remaining life span can be detected, etc. Any information relating to the filter and/or filter media cartridge can be detected.

In another embodiment, an engine is provided that includes a filtration system that includes the filter housing, the filter media cartridge, and the wireless tag mounted on the filter housing or on the filter media cartridge. In addition, a tag reader is mounted on the engine and in wireless communication with the wireless tag.

### DRAWINGS

FIG. 1 is a schematic illustration of the system described herein.

FIG. 2 illustrates an exemplary communication scheme in an engine.

FIG. 3 illustrates an exemplary network scheme involving multiple engines.

### DETAILED DESCRIPTION

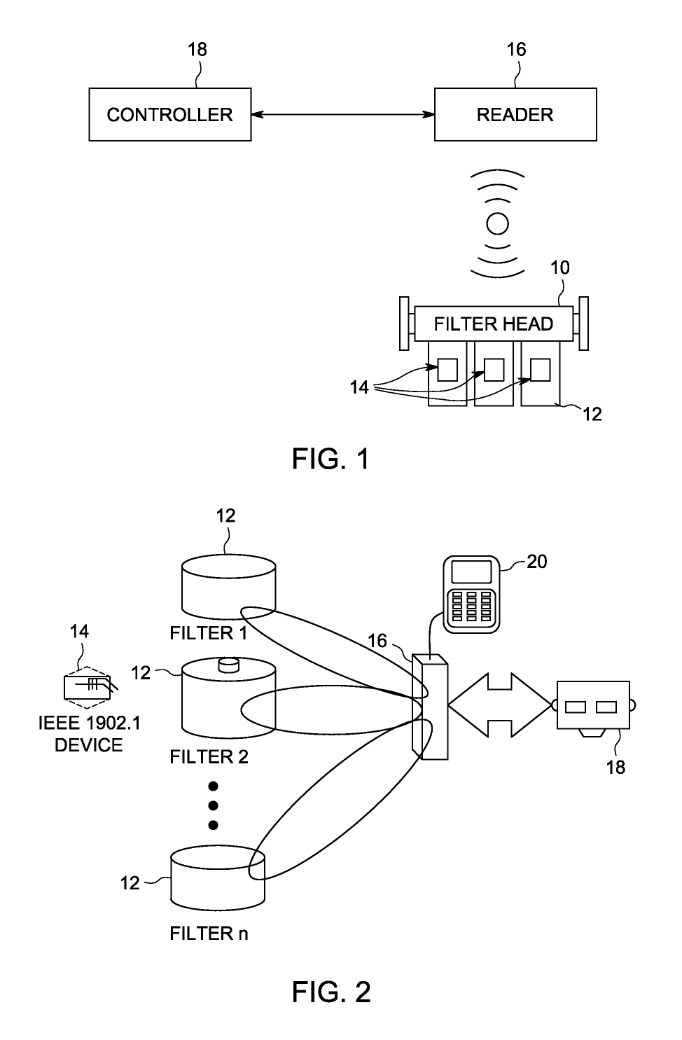

With reference to FIG. 1, a filter head 10 of an engine is illustrated on which one or more filters 12 are removably installed in a known manner. The filters 12 can be configured to filter any type of engine fluid, for example oil, fuel, hydraulic fluid, or air. In addition, although the head 10 is described as being in an engine, the head can be part of any mechanical system to which one or more filters are removably installed.

Various constructions of filters are known. In one embodiment, the filter 12 can include a filter housing and a filter media cartridge disposed inside the filter housing. The filter housing includes means, such as threads, for attaching the filter housing to the filter head. In one embodiment, the filter housing and the filter media cartridge are integral and thrown away as a unit. An example of this type of filter is a spin-on filter where a nut plate closes the end of the filter housing and the filter media cartridge is essentially permanently installed inside the filter housing. In another embodiment, the filter media cartridge is removable from the filter housing after the filter housing is detached from the filter head and replaced with a new filter media cartridge.

In one embodiment, a wireless tag device 14 is secured to each of the filters 12. In another embodiment, the wireless tags 14 associated with each filter 12 are secured to the head 10 rather than to the filters. In one example, the tags 14 can be IEEE 1902.1 wireless tags that use long wave magnetic waves to communicate, or any other similar type of long wave wireless tag that can communicate with a reader using magnetic waves in a wireless fashion. An IEEE 1902.1 wireless tag is a tag that operates on the IEEE 1902.1 protocol using magnetic waves, while RFID tags use radio waves. The tags 14 have a communication element, for example an antenna, and memory that stores certain data relating to the filter 12. The stored data can include, but is not limited to, an identifier that identifies the filter and/or the filter media cartridge installed therein, the manufacturer, date of manufacture, when the filter or the filter media cartridge was installed, status of the filter or the filter media cartridge and the like. For example, a reader/writer could send a “status” to the tag to say “installed” or “storage” or the like. The status can be manually updated. The tag could also store data relating to the engine that the filter and filter media is installed in, including, but not limited to, the engine serial number or some other way of identifying which engine the tag is installed on.

The wireless tag 14 can be secured to the filter housing, the filter media cartridge, or some other component of the filter, or to the filter head 10. The tag 14 can be secured to an exterior surface of the filter, for example to the filter housing, or to a suitable surface on the interior of the filter, such as the inside surface of the filter housing or to the filter media cartridge installed inside the filter housing. The filter media cartridge can include a ring of filtration media having a first end and a second end and circumscribing a central cavity, a first endplate sealingly attached to the first end of the filtration media to close the first end of the media, and a second endplate sealingly attached to the second end of the filtration media to close the second end of the media. The first endplate and/or the second endplate can include various openings to allow passage of fluid or fluid passageways such as a standpipe. The wireless tag can be attached to, for example, the first or second endplate. With reference to FIGS. 1 and 2, the system also includes a reader/writer 16 for reading and/or writing to the tags 14. In one embodiment, the reader/writer 16 is installed on or near the engine at a location to permit the reader/writer 16 to read data from and/or write data to the tags 14. In another embodiment, the reader/writer 16 is a portable device, such as a device specifically constructed for the purpose or a mobile smartphone device, that is not permanently installed on or near the engine, but is instead brought into sufficient proximity to the tags 14 to read from and/or write to the tags 14.

The reader/writer 16 is in communication with a controller 18. In the example environment of an engine, the controller 18 can be the engine control module (ECM). However, the controller 18 can take other forms suitable for interpreting, analyzing, acting on, or other processing data read from the tags 14 and/or preparing data to be written to the tags 14, for example a smartphone device 20 as illustrated in FIG. 2 that can communicate with the reader/writer wirelessly or via wires. The communications between the reader/writer 16 and the controller 18 can be wired or wireless, and in analog and/or digital form.

In another embodiment, the reader/writer 16 can include optional network communication and security features including, but not limited to, a router/firewall, and/or data storage and data processing features including, but not limited to a data acquisition system, and/or the reader/writer 16 could include a modem for remotely communicating data.

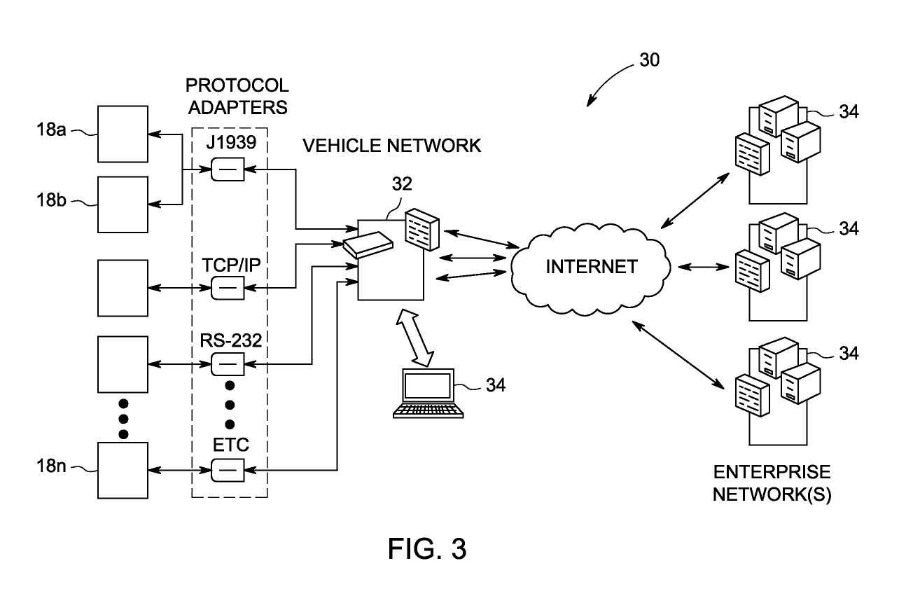

FIG. 3 illustrates a network 30 involving multiple systems of FIGS. 1 and 2. The network 30 includes a plurality of controllers 18a, 18b, . . . 18n that in the illustrated embodiment are on one vehicle. A communication device 32, for example having router, modem and firewall capability, is connected to the controllers 18a-n. The communication device 32 can be, for example, part of a vehicle network in a vehicle in which the engine is mounted. A local computing device 34 can be selectively connected with the device 32 to configure the vehicle network and the firewall of the device 32, and read data from and/or write data to the wireless tags. Alternatively, the device 32 can communicate with remote networks 34, such as servers, via the internet or via wired connections.

In addition, the presence of the wireless tags 14 can enable the tracking of the filters and/or filter media cartridges during engine assembly and assist with managing filter inventory at distribution centers. As electronics become more pervasive, it becomes desirable to treat the wireless tags as an addressable node on the internet and each engine can become an extension of an existing information technology network where the on-board (engine) computing devices communicate directly with the existing network. The use of wireless tags such as IEEE 1902.1 wireless tags enables this capability.

In addition, while the description has focused on filters, the wireless tags could be used for almost any engine component.

Although any suitable wireless tags could be used, the use of IEEE1902.1 communication protocol offers several advantages:

Wireless communication—removable filters and removable filter media cartridges cannot easily be connected to wiring harnesses

The reader/writer covers a defined volume, rather than line-of-sight, and ability to read is not diminished by metal, water, EMI noise—this allows the transmitter of the tag device to be embedded inside a metal filter housing, which is installed on a metal engine

The transmitter has low energy use—enables long battery life

Low cost transmitter since the transmitter could be embedded in the filter media cartridge.

The wireless tags can be applied to any engine components to be sensed, in particular filters, in particular oil or fuel filters. The wireless tags can be applied to the housing and/or the filter media cartridge of an integrated filter where the filter media cartridge and the housing are disposable together, in which case the wireless tag is disposed of unless removed prior to disposal. Alternatively, the wireless tags can be applied to a removable filter media cartridge that is removed from a permanent filter housing for disposal, in which case the wireless tag is disposed of unless removed prior to disposal. In some circumstances, the wireless tags can be applied to a permanent filter housing, in which case the wireless tag is intended to be generally permanent or at least reusable.

In addition, one or more readers/writers can be mounted on the engine. The reader(s)/writer(s) can communicate with the controller 18 via analog or digital signals, with the controller taking appropriate action (e.g. fault code/derate/shutdown) if necessary.

The use of IEEE 1902.1 wireless communication protocol or similar is important because it uses magnetic waves instead of the radio waves used in typical RFID systems. Therefore, the reader/writer 16 covers a defined volume, rather than relying on line-of-sight or close proximity. In addition, the read/write ability of the reader/writer is not diminished by metal, water, or EMI noise. In traditional RFID technology, the metal in an engine, particularly the iron, would interfere with the communications.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A system comprising:
a filter head;
a filter removably attached to the filter head;
a wireless tag that communicates using long wave magnetic waves mounted on the filter head or on the filter.

2. The system of claim 1, wherein the wireless tag is mounted on the filter.

3. The system of claim 1, wherein the filter head is located in an engine.

4. The system of claim 1, wherein the filter is a fuel filter or an oil filter.

5. The system of claim 4, wherein the filter includes a filter housing that is configured to detachably attach to the filter head, and a filter media cartridge disposed inside the filter housing; and the wireless tag is mounted on the filter housing or on the filter media cartridge.

6. The system of claim 4, wherein the filter media cartridge is removably disposed within the filter housing, and the wireless tag is mounted on the filter media cartridge.

7. The system of claim 1, wherein the wireless tag is an IEEE 1902.1 wireless tag.

8. The system of claim 1, further comprising a reader that can communicate with the wireless tag.

9. The system of claim 8, further comprising a controller in communication with the reader.

10. A filter, comprising:
a filter housing, the housing being configured to detachably attach to a filter head;
a filter media cartridge disposed inside the filter housing; and
a wireless tag that communicates using long wave magnetic waves mounted on the filter housing or on the filter media cartridge.

11. The filter of claim 10, wherein the filter is a fuel filter or an oil filter.

12. The filter of claim 10, wherein the wireless tag is an IEEE 1902.1 wireless tag.

13. The filter of claim 10, wherein the filter media cartridge is removably disposed within the filter housing, and the wireless tag is mounted on the filter media cartridge.

14. A filter media cartridge, comprising:
a ring of filtration media having a first end and a second end and circumscribing a central cavity;
a first endplate sealingly attached to the first end of the filtration media;
a second endplate sealingly attached to the second end of the filtration media;
a wireless tag that communicates using long wave magnetic waves mounted on the filter media cartridge.

15. The filter media cartridge of claim 14, wherein the wireless tag is mounted on the first endplate or on the second endplate.

16. The filter media cartridge of claim 14, wherein the wireless tag is an IEEE 1902.1 wireless tag.
